(19) United States
(12) Patent Application Publication
(10) Pub. No.: US 2013/0291089 A1
(43) Pub. Date: Oct. 31, 2013

(54) DATA COMMUNICATION METHOD AND DEVICE AND DATA INTERACTION SYSTEM BASED ON BROWSER

(71) Applicants: Xiaofeng Wang, Guangdong (CN); Jiong Tang, Guangdong (CN)

(72) Inventors: Xiaofeng Wang, Guangdong (CN); Jiong Tang, Guangdong (CN)

(73) Assignee: TENCENT TECHNOLOGY (SHENZHEN) COMPANY LIMITED, Guangdong (CN)

(21) Appl. No.: 13/976,523

(22) PCT Filed: Aug. 11, 2011
(86) PCT No.: PCT/CN2011/078293

§ 371 Date: Jun. 27, 2013

(30) Foreign Application Priority Data
Dec. 30, 2010 (CN) 201010624611.5

(51) Int. Cl. G06F 21/60

(52) U.S. Cl. CPC G06F 21/606
USPC 726/14

(57) ABSTRACT

The present invention, relating to the field of network technologies, discloses a data communication method and device and data interaction system based on browser. The method includes: receiving request data input by a user by using a browser; generating a request data packet using the request data according to a preset private protocol; and sending the request data packet to a server. The client includes: a receiving unit, a generating unit, and a sending unit. The data interaction system includes a client and a server. According to the present invention, a request data packet is generated for request data according to a preset private protocol, and then sent to a server. In addition, during the data communication process, other protocol-specific fields in HTTP are not carried, thereby reducing data transmission amount, saving bandwidths, and improving data transmission efficiency.

### FIELD OF THE INVENTION

The present invention relates to the field of network technologies, and in particular, to a data communication method and device and data interaction system based on browser.

### BACKGROUND OF THE INVENTION

With the development of the Internet, more and more users acquire their desired information over the Internet, and Flash files are concerned by many users because they embody rich media, such as simple animations, videos, presentation files, application programs, and connections thereof. No matter simple Flash animations or complicated Flash games, data communication needs to be implemented by data interaction performed between a client and a server by using a browser. Specifically, the client sends request data based on the browser, receives response data returned by a web server, and implements data communication with the server by using the Internet Protocol.

At present, in browser-based data communication mode, the client accesses, by using the Hypertext Transfer Protocol (HTTP), hypertext information stored on the web server, and receives, by using HTTP, web pages or other data content sent by the web server, thereby implementing data communication.

During implementation of the present invention, the inventors find that the prior art has at least the following problems: When the client performs data communication with the web server, data is transmitted by using HTTP during the communication interaction. All headers in HTTP need to be loaded to the data to be transmitted. Since HTTP specifies a lot of protocol fields, the data transmission amount is large, and too much bandwidth is occupied. In addition, the data processing capability gradually becomes a bottleneck.

### SUMMARY OF THE INVENTION

To reduce data transmission amount, save bandwidth and enhance data processing capabilities, embodiments of the present invention provide a data communication method and device and data interaction system based on browser. The technical solutions are as follows:

In one aspect, a data communication method based on browser is provided, where the method includes:

receiving request data input by a user by using a browser;

generating a request data packet using the request data according to a preset private protocol; and

sending the request data packet to a server.

Further, the sending the request data packet to a server specifically includes:

sending the request data packet to the server by using a socket interface.

Alternatively, after the generating a request data packet using the request data according to a preset private protocol, the method further includes:

encrypting the request data packet according to a preset key.

Alternatively, Further, prior to the sending the request data packet to a server, the method further includes:

sending a connection request to the server by using HTTP such that the server returns a response message for establishing a connection with the server;

where the sending the request data packet to a server specifically includes: sending the request data packet to the server by using the established connection.

Preferably, the preset private protocol is specifically a protocol containing a socket request data header not larger than 30 bytes.

In another aspect, a data communication method based on browser is provided, where the method includes:

receiving a request data packet; and

verifying whether the header of the request data packet is valid, and if the header is valid, generating request data using the request data packet according to a preset private protocol.

Alternatively, after the generating a request data packet using the request data according to a preset private protocol, the method further includes:

acquiring response data according to the request data;

generating a response data packet using the response data according to the preset private protocol; and

sending the response data packet to a client.

Further, the sending the response data packet to a client specifically includes:

sending the response data packet to the client by using a socket interface.

Alternatively, after the verifying whether a header of the request data packet is valid, the method further includes:

verifying, according to a preset key, whether the key to the request data packet is valid, and if the key is valid, performing the step of generating request data using the request data packet according to the preset private protocol.

Preferably, the preset private protocol is specifically a protocol containing a socket request data header not larger than 30 bytes.

In another aspect, a data interaction method based on browser is provided, where the method includes:

receiving, by a client, request data input by a user by using a browser, generating a request data packet using the request data according to a preset private protocol, and sending the request data packet to a server; and

receiving, by the server, the request data packet, verifying whether the header of the request data packet is valid, and if the header is valid, generating request data using the request data packet according to a preset private protocol.

In another aspect, a client is provided, where the client includes:

a receiving unit, configured to receive request data input by a user by using a browser;

a generating unit, configured to generate, according to a preset private protocol, a request data packet using the request data received by the receiving unit; and

a sending unit, configured to send the request data packet generated by the generating unit to a server.

Further, the sending unit is specifically configured to send the request data packet to the server by using a socket interface.

Alternatively, the client further includes:

an encrypting unit, configured to encrypt, according to a preset key, the request data packet generated by the generating unit.

Alternatively, the client further includes:

a connecting unit, configured to: before the sending unit sends the request data packet to the server, send a connection request to the server by using HTTP such that the server returns a response message for establishing a connection with the server;

where the sending unit is specifically configured to send the request data packet to the server by using the established connection.

In another aspect, a server is provided, where the server includes:

a receiving unit, configured to receive a request data packet;

a first verifying unit, configured to verify whether the header of the request data packet received by the receiving unit is valid; and

a first generating unit, configured to: when the first verifying unit verifies that the header of the request data packet is valid, generate request data using the request data packet according to a preset private protocol.

Alternatively, the server further includes:

a second generating unit, configured to acquire response data according to the request data generated by the first generating unit, and generate a response data packet using the response data according to the preset private protocol; and

a sending unit, configured to send the response data packet generated by the second generating unit to a client.

Further, the sending unit is specifically configured to send the response data packet to the server by using a socket interface.

Alternatively, the server further includes:

a second verifying unit, configured to: when the first verifying unit verifies that the header of the request data packet is valid, verify, according to a preset key, whether the key to the request data packet is valid, wherein if the header is valid, the step of generating request data using the request data packet by the first generating unit according to the preset private protocol is performed.

In another aspect, a data interaction system based on browser is provided, where the system includes: a client and a server.

The client is a client as described above.

The server is a server as described above.

The technical solutions provided in the embodiments of the present invention achieve the following beneficial effects:

A request data packet is generated using request data according to a preset private protocol, and then sent to a server. This process, compared with the existing process of sending request data to a browser by using HTTP whereupon the browser sends the request data to the server by using HTTP, reduces intermediate processes during data communication. In addition, during the data communication process, other protocol-specific fields in HTTP are not carried, thereby reducing data transmission amount, saving bandwidth, and improving data transmission efficiency.

### BRIEF DESCRIPTION OF THE DRAWINGS

For a better understanding of the technical solutions in the embodiments of the present invention, the accompanying drawings for illustrating the embodiments are briefly described below. Apparently, the accompanying drawings in the following description illustrate only some embodiments of the present invention, and a person skilled in the art can derive other accompanying drawings from these accompanying drawings without any creative efforts.

FIG. 1 is a schematic structural diagram of five-layer protocols of the Transmission Control Protocol/Internet Protocol (TCP/IP) suite in the prior art;

FIG. 2 is a flowchart of a data communication method based on browser according to Embodiment 1 of the present invention;

FIG. 3 is a flowchart of a data communication method based on browser according to Embodiment 2 of the present invention;

FIG. 4 is a flowchart of a data communication method based on browser according to Embodiment 3 of the present invention;

FIG. 5 is a flowchart of a data communication method based on browser according to Embodiment 4 of the present invention;

FIG. 6 is a flowchart of a data interaction method based on browser according to Embodiment 5 of the present invention;

FIG. 7 is a schematic structural diagram of a client according to Embodiment 6 of the present invention;

FIG. 8 is a schematic structural diagram of another client according to Embodiment 6 of the present invention;

FIG. 9 is a schematic structural diagram of still another client according to Embodiment 6 of the present invention;

FIG. 10 is a schematic structural diagram of a server according to Embodiment 7 of the present invention;

FIG. 11 is a schematic structural diagram of another server according to Embodiment 7 of the present invention;

FIG. 12 is a schematic structural diagram of still another server according to Embodiment 7 of the present invention; and

FIG. 13 is a schematic structural diagram of a data interaction system based on browser according to Embodiment 8 of the present invention.

### DETAILED DESCRIPTION OF THE EMBODIMENTS

To make the objectives, technical solutions, and advantages of the present invention clearer, the following describes the embodiments of the present invention in detail below with reference to the accompanying drawings.

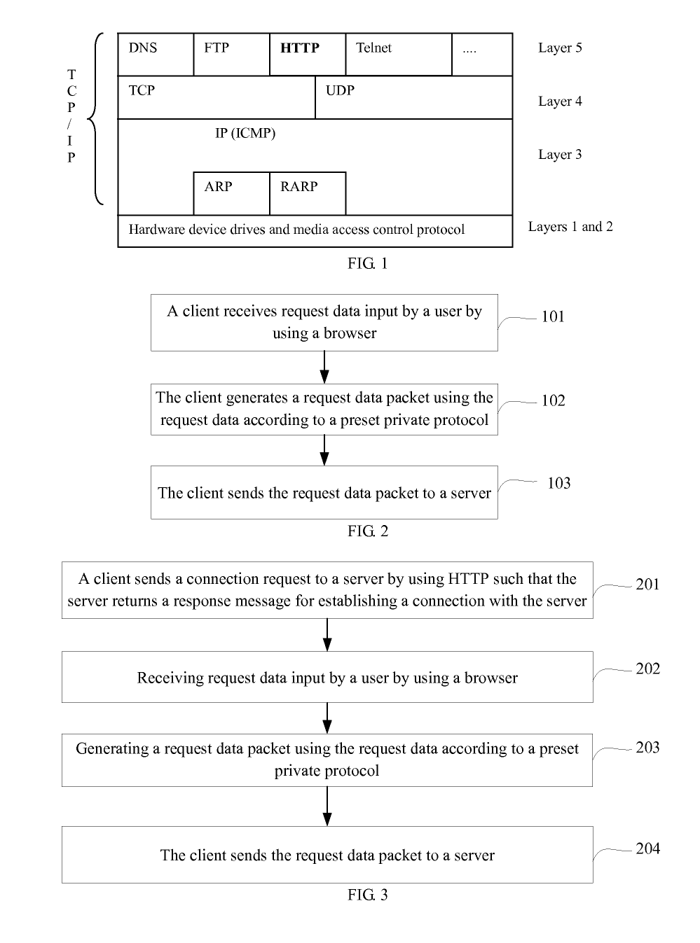

FIG. 1 illustrates five-layer architecture of TCP/IP. Layers 1 and 2 are network interface layers, including hardware device drives and media access control protocol; Layer 3 is the Internet Group Message Protocol (ICMP) interconnection network layer, including the Address Resolution Protocol (ARP), and the Reverse Address Resolution Protocol (RARP); Layer 4 is the transportation layer, including the Transmission Control Protocol (TCP), and the User Data Protocol (UDP); Layer 5 is the application layer, including the Domain Name System (DNS) protocol, the File Transfer Protocol (FTP), Hyper Text Transfer Protocol (HTTP), and the Telecommunications Network (Telnet). In the prior art, data communication is performed between a client and a server by using HTTP on the fifth layer of TCP/IP. In embodiments of the present invention, improvements and innovations are made on the fifth layer.

### Embodiment 1

Referring to FIG. 2, an embodiment of the present invention provides a data communication method based on browser, including the following steps:

101: A client receives request data input by a user by using a browser.

102: The client generates a request data packet using the request data according to a preset private protocol.

103: The client sends the request data packet to a server.

According to the method provided in the embodiments of the present invention, a request data packet is generated using request data according to a preset private protocol, and then sent to a server. This process, compared with the existing process of sending request data to a browser by using HTTP whereupon the browser sends the request data to the server by using HTTP, reduces intermediate processes during data communication. In addition, during the data communication process, other protocol-specific fields in HTTP are not carried, thereby reducing data transmission amount, saving bandwidth, and improving data transmission efficiency.

### Embodiment 2

Referring to FIG. 3, with respect to a client, an embodiment of the present invention provides a data communication method based on browser, including the following steps:

201: A client sends a connection request to a server by using HTTP such that the server returns a response message for establishing a connection with the server.

This embodiment provides a Flash file. After the Flash file is loaded to the browser, the Flash file connects to a security policy server by using the Extensive Markup Language (XML) socket, and acquires a security policy file. After the security policy file is successfully acquired, the Flash file is authorized to access a port on a private server by using socket. By using the socket created by the Flash file, the client can connect to the server. The server in this embodiment is a private server.

In this step, the client can send a connection request to the private server by using the socket interface, and after acquiring a response message returned by the private server, the client establishes a private connection with the private server. The embodiments of the present invention use connection establishment between a client and a server by using an XML socket interface as an example to describe the present invention. In practice, other socket connection modes may also be used, and the connection mode is not limited in the present invention.

202: Receiving request data input by a user by using a browser.

Specifically, the embodiments of the present invention are invented based on a browser; the user inputs the request data based on the browser such that the request data is sent to the server by using a preset private protocol. For example, the user sends the request data for visit to the client by using the browser; the browser serves only as a bearer for inputting the request data, and the input data is not stored on the browser but on the client.

203: Generating a request data packet using the request data according to a preset private protocol.

In the embodiments of the present invention, a Flash programming module is set on the client, after the client receives the request data input by the user, Flash request data is generated using the request data by the Flash programming module. With respect to Flash file communication services provided by various websites, the client generates a request data packet using the Flash request data according to a preset private protocol. The preset private protocol is a protocol containing a socket request data header not larger than 30 bytes, and is a binary byte stream-based protocol. The preset private protocol is not publically disclosed, thereby ensuring security of data communication and preventing the data from being falsified by an unauthorized client. In addition, compared with the data packaged by using HTTP in the prior art, the preset private protocol reduces the amount of data to be transmitted. The private protocol is stipulated between the client and the server in advance. The client packages the request data according to the preset private protocol and sends the request data packet to the server, and the server processes the request data packet according to the preset private protocol and returns a corresponding response data packet.

204: The client sends the request data packet to a server.

After establishing a connection with the server, the client sends the data packet packaged according to the preset private protocol to the server by using the established connection, thereby implementing communication between the client and the server. Preferably, the request data packet may also be sent by using the socket interface.

Alternatively, after step 203, the method according to the embodiments of the present invention further includes: encrypting the request data packet according to a preset key; and correspondingly, in step 204, the encrypted request data packet is sent. Encrypting the request data packet on the client enhances security of data transmission and prevents the transmitted data from being falsified by an unauthorized client.

Specifically, after generating the request data packet, the client encrypts the request data packet according to a preset key. To be specific, the client may encrypt the header of the request data packet, or encrypt the body of the request data packet, or encrypt the header and body of the request data packet respectively. The key for encrypting the header of the request data packet may be different from that for encrypting the body of the request data packet, which is not limited in the present invention. The encryption step is an optimized step. Encrypting the request data packet enhances security of data transmission, and prevents the transmitted data from being falsified by an unauthorized client.

In addition, in step 204, before the request data packet is sent to the server, the body of the request data packet may also be compressed to reduce data amount.

According to the data communication method provided in the embodiments of the present invention, a request data packet is generated using request data according to a preset private protocol, and then sent to a server. This process, compared with the existing process of sending request data to a browser by using HTTP whereupon the browser sends the request data to the server by using HTTP, reduces intermediate processes during data communication. In addition, during the data communication process, other protocol-specific fields in HTTP are not carried, and the header of the request data packet generated according to the preset private protocol is 2% of that of a request data packet generated according to HTTP, thereby reducing data transmission amount, saving bandwidth, and improving data transmission efficiency. In addition, data transmission is based on the preset private protocol instead of a plain text protocol, thereby enhancing security of data communication. Even if the transmitted data is intercepted, the intercepted data is useless. In addition, encrypting the request data packet prior to transmission further enhances security of data communication.

### Embodiment 3

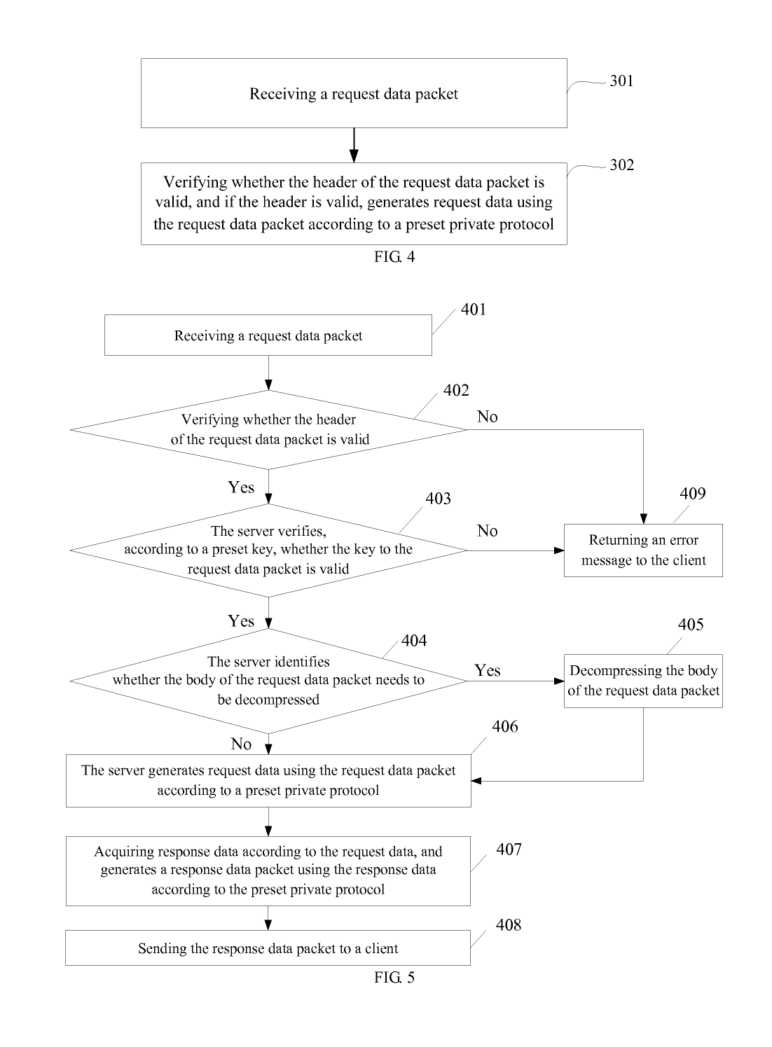

Referring to FIG. 4, an embodiment of the present invention provides a data communication method based on browser, including the following steps:

301: Receiving a request data packet.

302: Verifying whether the header of the request data packet is valid, and if the header is valid, generate request data using the request data packet according to a preset private protocol.

The method further includes: acquiring response data according to the request data; generating a response data packet using the response data according to the preset private protocol; and sending the response data packet to a client by using the browser.

According to the data communication method provided in the embodiments of the present invention, a response data packet is generated using response data according to a preset private protocol, and then sent to a client. This process, compared with the existing process of sending response data to a browser by using HTTP whereupon the browser sends the response data to the client, reduces intermediate processes during data communication. In addition, during the data communication process, other protocol-specific fields in HTTP are not carried, thereby reducing data transmission amount, saving bandwidth, and improving data transmission efficiency.

### Embodiment 4

Referring to FIG. 5, with respect to a server, an embodiment of the present invention provides a data communication method based on browser, including the following steps:

401: Receiving a request data packet.

In this step, the server receives the request data packet from a client, and processes the request data packet according to a preset private protocol. The private protocol is stipulated between the server and the client in advance. The preset private protocol is specifically a protocol containing a socket request data header not larger than 30 bytes, and is a binary byte stream-based protocol. The preset private protocol is not publically disclosed, thereby ensuring security of data communication and preventing the data from being falsified by an unauthorized client.

402: Verifying whether the header of the request data packet is valid; if the header is valid, step 403 is performed; otherwise, step 409 is performed.

Specifically, the server verifies the header of the request data packet according to a predetermined verification mode between the server and the client. The specific verification mode is not limited in the embodiments of the present invention. For example, the server and the client may stipulate that the header is valid if the header contains specific content. To be specific, if the header of a data packet received by the server contains the content, the header of the data packet is valid, and step 403 is performed; if the header of a data packet received by the server does not contain the content, the header of the data packet is invalid, an invalidity indication message is returned to the client, and the process ends.

403: The server verifies, according to a preset key, whether the key to the request data packet is valid; if the key is valid, step 404 is performed; otherwise, step 409 is performed.

The server decrypts the header and/or the body of the request data packet according to the preset key stipulated with the client in advance, and verifies whether the key to the data packet is valid. If the decryption is successful, the key to the request data packet is valid, and step 404 is performed; otherwise, the server returns an error message to the client and the process ends. In the embodiments of the present invention, verifying whether the key to the request data packet is valid is to verify validity of the request data packet sent by the client, provides a basis for the verification of an invalid data packet, and enhances data security by increasing complexity in data falsification.

Specifically, if the client only encrypts the header of the request data packet, when successfully decrypting the header of the request data packet, the server verifies that the key to the request data packet is valid, and it is ensured that the request data packet comes from an authorized client; if the client only encrypts the body of the request packet, when successfully decrypting the body of the request data packet, the server verifies that the key to the request data packet is valid; if the client encrypts both the header and the body of the request data packet, when successfully decrypting the header and the body of the request data packet, the server verifies that the key to the request data packet is valid; in other cases, the server returns the error message to the client and the process ends.

404: The server identifies whether the body of the request data packet needs to be decompressed; if the body needs to be decompressed, step 405 is performed; otherwise, step 406 is performed.

Specifically, if the client compresses the body of the request data packet, correspondingly, the server needs to decompress the body of the request data packet.

405: Decompressing the body of the request data packet.

In practice, if identifying that the body of the request data packet needs to be decompressed, the server decompresses the body of the request data packet according to a decompression mode preset with the client. If the decompression is successful, step 406 is performed; otherwise, the server returns the error message to the client, and the process ends.

406: When no decompression is needed or the decompression is successful, generating request data using the request data packet according to the preset private protocol.

Specifically, the process of generating the request data using the request data packet by the server according to the preset private protocol is similar to the process of generating the request data packet using the request data by the client according to the preset private protocol, which is not described herein any further.

407: Acquiring response data according to the request data, and generating a response data packet using the response data according to the preset private protocol.

Specifically, the process of generating the response data packet using the response data by the server according to the preset private protocol is similar to the process of generating the request data packet using the request data by the client according to the preset private protocol, which is not described herein after further.

408: Sending the response data packet to the client, and the process ends.

After the server sends the response data packet generated according to the preset private protocol to the client, the client processes the response data packet according to the preset private protocol, thereby implementing communication between the server and the client. Preferably, the response data packet may be sent to the client by using a socket interface, such that the user acquires the response data by using the browser.

409: Returning an error message to the client, and the process ends.

According to the data communication method provided in the embodiments of the present invention, a response data packet is generated using response data according to a preset private protocol, and then sent to a client. This process, compared with the existing process of sending response data to a browser by using HTTP whereupon the browser sends the response data to the client, reduces intermediate processes during data communication. In addition, during the data communication process, other protocol-specific fields in HTTP are not carried, and the header of the request data packet generated according to the preset private protocol is 2% of that of a request data packet generated according to HTTP, thereby reducing data transmission amount, saving bandwidth, and improving data transmission efficiency. In addition, data transmission is based on the preset private protocol instead of a plain text protocol, thereby enhancing security of data communication. Even if the transmitted data is intercepted, the intercepted data is useless. In addition, encrypting the request data packet prior to transmission further enhances security of data communication.

### Embodiment 5

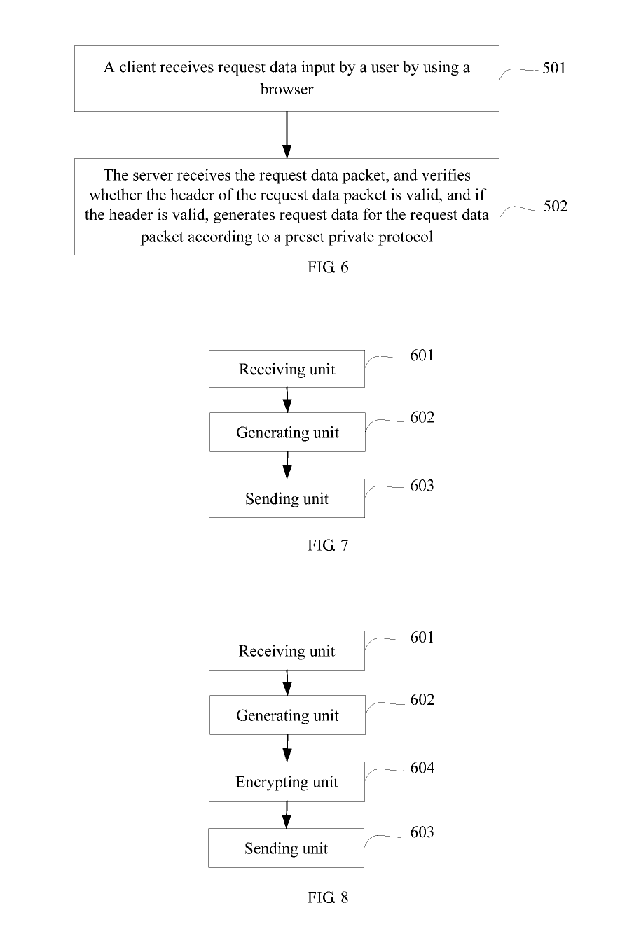

Referring to FIG. 6, an embodiment of the present invention provides a data interaction method based on browser, including the following steps:

501: A client receives request data input by a user by using a browser, generates a request data packet using the request data according to a preset private protocol, and sends the request data packet to a server.

This step achieves an effect that the request data packet is not only executed in the browser, but also subject to data interaction with the server independently.

502: The server receives the request data packet, and verifies whether the header of the request data packet is valid, and if the header is valid, generates request data using the request data packet according to a preset private protocol.

According to the data interaction method provided in the embodiments of the present invention, a client generates a request data packet using request data according to a preset private protocol, and then sends the request data packet to a server; and the server generates response data according to the received request data packet, generates a response data packet using the response data according to a preset private protocol, and sends the response data packet to the client, thereby implementing data interaction between the client and the server. This process, compared with the existing process of implementing data interaction between the client and the server by the client by using HTTP, reduces intermediate processes during data communication. In addition, during the data communication process, other protocol-specific fields in HTTP are not carried, and the header of the request data packet (or response data packet) generated according to the preset private protocol is 2% of that of a request data packet (or response data packet) generated according to HTTP, thereby reducing data transmission amount, saving bandwidth, and improving data transmission efficiency. In addition, data transmission is based on the preset private protocol instead of a plain text protocol, thereby enhancing security of data communication. Even if the transmitted data is intercepted, the intercepted data is useless.

### Embodiment 6

Corresponding to Embodiment 2, referring to FIG. 7, an embodiment of the present invention provides a client, where the client includes:

a receiving unit 601, configured to receive request data input by a user by using a browser;

a generating unit 602, configured to generate, according to a preset private protocol, a request data packet using the request data received by the receiving unit 601; and

a sending unit 603, configured to send the request data packet generated by the generating unit 602 to a server.

Further, the sending unit 603 is specifically configured to send the request data packet to the server by using a socket interface.

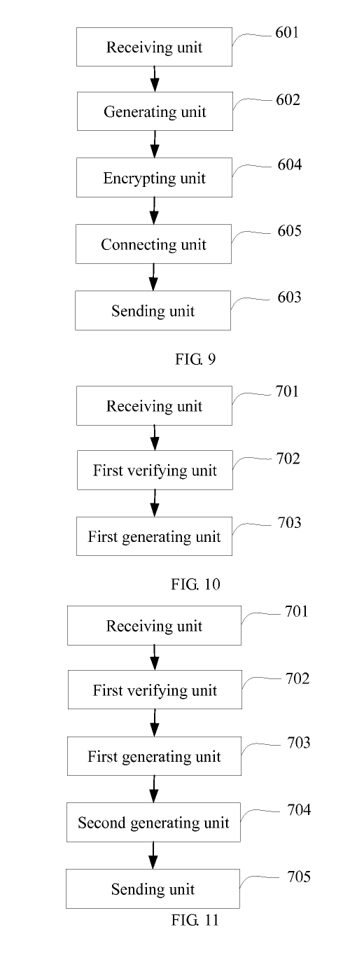

Alternatively, referring to FIG. 8, the client further includes:

an encrypting unit 603, configured to encrypt, according to a preset key, the request data packet generated by the generating unit 602; where the sending unit 603 is further configured to send the encrypted request data packet to the server.

Alternatively, referring to FIG. 9, the client further includes:

a connecting unit 605, configured to: before the sending unit 603 sends the request data packet to the server, send a connection request to the server by using the Hypertext Transfer Protocol (HTTP) such that the server returns a response message for establishing a connection with the server; where the sending unit 603 is specifically configured to send the request data packet to the server by using the connection established by the connecting unit 605.

According to the client provided in the embodiments of the present invention, a request data packet is generated using request data according to a preset private protocol, and then sent to a server. This process, compared with the existing client, is capable of directly sending the request data packet to the server, thereby reducing intermediate processes during data communication, saving bandwidth, and improving data transmission efficiency. In addition, encrypting the request data packet prior to transmission further enhances security of data communication.

### Embodiment 7

Corresponding to Embodiment 4, referring to FIG. 10, an embodiment of the present invention provides a server, where the server includes:

a receiving unit 701, configured to receive a request data packet;

a first verifying unit 702, configured to verify whether the header of the request data packet received by the receiving unit 701 is valid; and

a first generating unit 703, configured to: when the first verifying unit 702 verifies that the header of the request data packet is valid, generate request data using the request data packet according to a preset private protocol.

Alternatively, referring to FIG. 11, the server further includes:

a second generating unit 704, configured to acquire response data according to the request data generated by the first generating unit 703, and generate a response data packet using the response data according to a preset private protocol; and

a sending unit 705, configured to send the response data packet generated by the second generating unit 704 to a client.

Further, the sending unit 705 is specifically configured to send the response data packet to the client by using a socket interface.

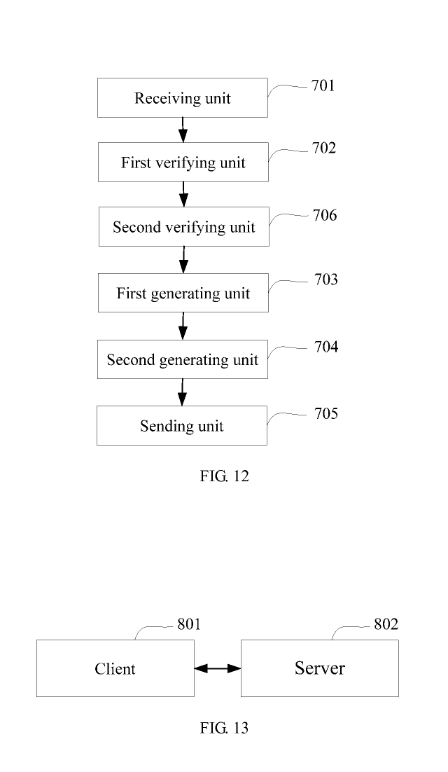

Alternatively, referring to FIG. 12, the server further includes:

a second verifying unit 706, configured to: when the first verifying unit 702 verifies that the header of the request data packet is valid, verify, according to a preset key, whether the key to the request data packet is valid, wherein if the header is valid, the step of generating request data for the request data packet by the first generating unit 703 according to a preset private protocol is performed.

According to the server provided in the embodiments of the present invention, a response data packet is generated using response data according to a preset private protocol, and then sent to a client. This process, compared with the existing server, is capable of directly sending the response data packet to the client, thereby reducing intermediate processes during data communication, saving bandwidth, and improving data transmission efficiency. In addition, encrypting the response data packet prior to transmission further enhances security of data communication.

### Embodiment 8

Referring to FIG. 13, an embodiment of the present invention provides a data interaction system based on browser, where the data interaction system includes: a client 801 and a server 802.

The client 801 is a client as described in Embodiment 6.

The server 802 is a server as described in Embodiment 7.

According to the data interaction system provided in the embodiments of the present invention, a client generates a request data packet for request data according to a preset private protocol, and then sends the request data packet to a server; and the server acquires response data, generates a response data packet using the response data according to a preset private protocol, and sends the response data packet to a client, thereby implementing data interaction between the client and the server. This process, compared with the existing process of implementing data interaction between the client and the server by the client by using HTTP, reduces intermediate processes during data communication. In addition, during the data communication process, other protocol-specific fields in HTTP are not carried, and the header of the request data packet (or response data packet) generated according to the preset private protocol is 2% of that of a request data packet (or response data packet) generated according to HTTP, thereby reducing data transmission amount, saving bandwidth, and improving data transmission efficiency. In addition, the client and the server implements data interaction according to the preset private protocol instead of a plain text protocol, thereby enhancing security of data communication. Even if the transmitted data is intercepted, the intercepted data is useless. In addition, encrypting the request data packet (or response data packet) prior to transmission further enhances security of data communication.

It should be noted that, during data communication between the client and the server provided in the above embodiments, the client and the server according to the above embodiments are described by only using division of the above functional modules as an example. In practice, the functions may be assigned to different functional modules for implementation as required. To be specific, the internal structures of the client and the server are divided into different functional modules to implement all or part of the above-described functions. In addition, the client and server and the data communication method provided in the embodiments of the present invention pertain to the same concept, and the specific implementation thereof is elaborated in the method embodiments, which is not be described herein any further.

The sequence numbers of the preceding embodiments of the present invention are only for ease of description, but do not denote the preference of the embodiments.

A person skilled in the art should understand that all or part of steps of the preceding methods may be implemented by hardware or hardware following instructions of programs. The programs may be stored in a computer readable storage medium. The storage medium may be a read only memory, a magnetic disk, or a compact disc-read only memory.

Described above are merely preferred embodiments of the present invention, but are not intended to limit the present invention. Any modification, equivalent replacement, or improvement made without departing from the spirit and principle of the present invention should fall within the protection scope of the present invention.

1. A data communication method based on browser, comprising:
receiving request data input by a user by using a browser;
generating a request data packet using the request data according to a preset private protocol; and
sending the request data packet to a server.

2. The method according to claim 1, wherein the sending the request data packet to a server specifically comprises: sending the request data packet to the server by using a socket interface.

3. The method according to claim 1, wherein after the generating a request data packet using the request data according to a preset private protocol, the method further comprises: encrypting the request data packet according to a preset key.

4. The method according to claim 1, wherein prior to the sending the request data packet to a server, the method further comprises:
sending a connection request to the server by using the Hypertext Transfer Protocol (HTTP) such that the server returns a response message for establishing a connection with the server;
wherein the sending the request data packet to a server specifically comprises: sending the request data packet to the server by using the established connection.

5. The method according to claim 1, wherein the preset private protocol is specifically a protocol containing a socket request data header not larger than 30 bytes.

6. A data communication method based on browser, comprising:
receiving a request data packet; and
verifying whether the header of the request data packet is valid, and if the header is valid, generating request data for the request data packet according to a preset private protocol.

7. The method according to claim 6, wherein after the generating request data for the request data packet according to a preset private protocol, the method further comprises:
acquiring response data according to the request data;
generating a response data packet for the response data according to the preset private protocol; and
sending the response data packet to a client.

8. The method according to claim 7, wherein the sending the response data packet to a client specifically comprises:
sending the response data packet to the client by using a socket interface.

9. The method according to claim 6, wherein after the verifying whether the header of the request data packet is valid, the method further comprises:
verifying, according to a preset key, whether the key to the request data packet is valid, and if the key is valid, performing the step of generating request data using the request data packet according to the preset private protocol.

10. The method according to claim 6, wherein the preset private protocol is specifically a protocol containing a socket request data header not larger than 30 bytes.

11. A data interaction method based on browser, comprising:
receiving, by a client, request data input by a user by using a browser, generating a request data packet using the request data according to a preset private protocol, and sending the request data packet to a server; and
receiving, by the server, the request data packet, and verifying whether the header of the request data packet is valid, and if the header is valid, generating request data using the request data packet according to the preset private protocol.

12. A client, comprising:
a receiving unit, configured to receive request data input by a user by using a browser;
a generating unit, configured to generate, according to a preset private protocol, a request data packet using the request data received by the receiving unit; and
a sending unit, configured to send the request data packet generated by the generating unit to a server.

13. The client according to claim 12, wherein the sending unit is specifically configured to send the request data packet to the server by using a socket interface.

14. The client according to claim 12, further comprising:
an encrypting unit, configured to encrypt, according to a preset key, the request data packet generated by the generating unit.

15. The client according to claim 12, further comprising:
a connecting unit, configured to: before the sending unit sends the request data packet to the server, send a connection request to the server by using the Hypertext Transfer Protocol (HTTP) such that the server returns a response message for establishing a connection with the server;
wherein the sending unit is specifically configured to send the request data packet to the server by using the connection established by the connecting unit.

16. A server, comprising:
a receiving unit, configured to receive a request data packet;
a first verifying unit, configured to verify whether the header of the request data packet received by the receiving unit is valid; and
a first generating unit, configured to: when the first verifying unit verifies that the header of the request data packet is valid, generate request data using the request data packet according to a preset private protocol.

17. The server according to claim 16, further comprising:
a second generating unit, configured to acquire response data according to the request data generated by the first generating unit, and generate a response data packet using the response data according to the preset private protocol; and
a sending unit, configured to send the response data packet generated by the second generating unit to a client.

18. The server according to claim 17, wherein the sending unit is specifically configured to send the response data packet to the client by using a socket interface.

19. The server according to claim 16, further comprising:
a second verifying unit, configured to: when the first verifying unit verifies that the header of the request data packet is valid, verify, according to a preset key, whether the key to the request data packet is valid, wherein if the header is valid, the step of generating request data for the request data packet by the first generating unit according to a preset private protocol is performed.

20. A data interaction system based on browser, comprising: a client and a server;
wherein: the client is a client according to claim 12; and
the server is a server according to claim 16.
